(19) United States
(12) Patent Application Publication
(10) Pub. No.: US 2025/0361183 A1
(43) Pub. Date: Nov. 27, 2025

(54) PLASTER MATERIAL COMPOSITION FOR USE IN CONSTRUCTION AND METHODS OF PREPARING THE SAME

(71) Applicant: ONX, INC., Carrollton, TX (US)

(72) Inventor: Mohamed Kassim Jahaber, George Town (MY)

(21) Appl. No.: 18/674,455

(22) Filed: May 24, 2024

(51) Int. Cl. C04B 28/14; C04B 16/02; C04B 24/12; C04B 24/26; C04B 111/00; C04B 111/10

(52) U.S. Cl. CPC C04B 28/145; C04B 16/02; C04B 24/123; C04B 24/2623; C04B 2111/00508; C04B 2111/1037; C04B 2111/1056; C04B 2201/20; C04B 2201/32; C04B 2201/50

(57) ABSTRACT

A material composition for a bio-composite plaster material for use in construction is disclosed. The composition includes a binder, a filler, a polymer, and an additive. The binder includes calcium sulphate hemihydrate, the filler includes cork, the polymer includes vinyl acetate, and the additive includes modified amino acid. The filler is an agro-based bio fiber. The composition provides high thermal insulation. A method of preparing and using the composition includes preparing the composition, mixing the composition with water for a first predetermined amount of time to produce the bio-composite plaster material having a predetermined consistency, and applying a coat of the bio-composite plaster material on a surface during the construction activity.

### FIELD OF THE INVENTION

The present disclosure generally relates to material compositions formulated for architectural applications as plaster material as well as methods of preparing and using these compositions in construction related activities. In particular, the present disclosure relates to a sand-free and cement-free (green) bio-composite plaster material composition that when applied on a surface during construction activity, provides high thermal insulation.

### BACKGROUND OF THE INVENTION

Builders of both commercial and non-commercial buildings are constantly looking for new innovative products and materials in order to make buildings more environmentally friendly and energy efficient, to better protect them from the weather, and to make them more aesthetically pleasing, among other like objects.

One building material that is commonly used in construction is plaster material. It is generally used for providing superior rich and smooth finish to wall surfaces made up of various types of blocks, bricks, stone, and concrete. However, commercially available plaster materials are sand-based or cement-based, thus impacting the environment in various ways. For example, such commercially available plaster materials contribute to global warming, terrestrial acidification, marine and freshwater eutrophication, and photochemical ozone formation. Further, such commercially available plasters are typically designed for specific purposes. For example, some plaster materials provide low thermal conductivity, others provide high sound absorption. Further, certain plaster materials provide good acoustical performance while others offer good fire resistance.

Therefore, new, unified, and improved bio-plaster material compositions are needed that encompass the above-mentioned properties for use in construction related activities. The present disclosure provides such compositions as well as methods of making and using these compositions in construction activities.

### SUMMARY OF THE INVENTION

The following represents a summary of some embodiments of the present disclosure to provide a basic understanding of various aspects of the disclosed herein. This summary is not an extensive overview of the present disclosure. It is not intended to identify key or critical elements of the present disclosure or to delineate the scope of the present disclosure. Its sole purpose is to present some embodiments of the present disclosure in a simplified form as a prelude to the more detailed description that is presented below. Embodiments of material compositions and methods for manufacturing and using them in construction to address at least some of the above challenges and issues are disclosed.

In some aspects, the present disclosure is directed to a plaster material composition for use in construction. The plaster material composition for a bio-composite plaster material includes a binder, a filler, a polymer, and an additive. The binder includes calcium sulphate hemihydrate, the filler includes cork, the polymer includes vinyl acetate, and the additive includes modified amino acid. The filler is an agro-based bio fiber. The composition provides high thermal insulation.

In some embodiments, a quantity of the calcium sulphate hemihydrate is between 40-60% of the composition by volume, a quantity of the cork is between 40-60% of the composition by volume, a quantity of the modified amino acid is between 0.001-0.01% of the calcium sulphate hemihydrate by volume, and a quantity of the vinyl acetate is between 0.5-1% of the calcium sulphate hemihydrate by volume.

In some embodiments, an amount of water is added to the composition such that a homogeneous lump-free paste is formed with a consistency within a predetermined range.

In some embodiments, the bio-composite plaster material excludes curing for setting.

In some embodiments, the composition is cement-free.

In some embodiments, the composition is sand-free.

In some embodiments, a coat of the bio-composite plaster material is applied as a base coat to improve thermal resistance of substrates.

In some embodiments, a coat of the bio-composite plaster material is applied on internal wall surfaces.

In some embodiments, the bio-composite plaster material is used for a single coat application.

In some embodiments, properties of the composition include one or more of a compressive strength of at least 2 N/mm², a flexural strength of at least 1 N/mm², an initial setting time of between 0.45 to 0.60 minutes, a wet density of between 1100 to 1200 Kg/m³, and a thermal conductivity of between 0.1 to 0.2 W/m·K.

In some aspects, the present disclosure is directed to a method of using material composition. The method includes preparing the composition having a binder that includes calcium sulphate hemihydrate, a filler that includes cork, the filler being an agro-based bio fiber, a polymer that includes vinyl acetate, and an additive that includes modified amino acid.

In some embodiments, the method includes mixing the composition with water for a first predetermined amount of time to produce a bio-composite plaster material having a predetermined consistency.

In some embodiments, the method includes applying a coat of the bio-composite plaster material on a surface during the construction activity, the bio-composite plaster material providing high thermal insulation.

In some embodiments, the predetermined consistency includes a homogeneous lump-free paste.

In some embodiments, the method includes applying the coat of the bio-composite plaster material on internal wall surfaces.

In some embodiments, the method includes applying the coat of the bio-composite plaster material as a base coat to improve thermal resistance of substrates.

In some embodiments, the composition is used for a single coat application.

In some embodiments, the bio-composite plaster material excludes curing for setting.

In some aspects, the present disclosure is directed to a method of preparing a bio-composite plaster material. The method includes preparing a composition that includes a binder comprising calcium sulphate hemihydrate, a filler comprising cork, wherein the filler is an agro-based bio fiber, a polymer that includes vinyl acetate, and an additive that includes modified amino acid. The method further includes mixing the composition with water in a mixer for a first predetermined amount of time to produce a bio-composite plaster material having a predetermined consistency.

In some embodiments, the bio-composite plaster material provides high thermal insulation.

In some embodiments, the properties of the bio-composite plaster material comprise one or more of a compressive strength of at least 2 N/mm², a flexural strength of at least 1 N/mm², an initial setting time of between 0.45 to 0.60 minutes, a wet density of between 1100 to 1200 Kg/m³ and a thermal conductivity of between 0.1 to 0.2 W/m·K.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Further advantages of the disclosure will become apparent by reference to the detailed description of preferred embodiments when considered in conjunction with the drawings. In the drawings, identical numbers refer to the same or a similar element.

FIG. 1 illustrates ingredients collated in the form of a group that make up an exemplary material composition, in accordance with some embodiments of the present disclosure.

FIG. 2 illustrates an arrangement for manufacturing material compositions, in accordance with some embodiments of the present disclosure.

FIG. 3 illustrates the steps of a method for manufacturing material compositions for construction activities, in accordance with some embodiments of the present disclosure.

### DETAILED DESCRIPTION

The following detailed description is presented to enable any person skilled in the art to make and use the disclosure. For purposes of explanation, specific details are set forth to provide a thorough understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein may be applied to other embodiments and applications without departing from the scope of the disclosure. The present disclosure is not intended to be limited to the embodiments shown but is to be accorded the widest possible scope consistent with the principles and features disclosed herein.

Embodiments of the present solution provide new, unified, and improved bio-plaster material composition, with many advantages in architectural applications. By leveraging such material compositions in building architectures, the present disclosure provides a bio-plaster material that does not use cement or sand.

Material compositions for bio-plaster material in accordance with the embodiments are different from conventional plaster material. In some embodiments, these material compositions include a specific form of calcium sulfate, such as, calcium sulfate beta hemihydrate, as the sole binder, without the addition of any other hydraulic binders. Further, these material compositions include cork as a filler and both additives and polymers in a smaller fraction than their recommended amounts. The material compositions exclude any other lightweight aggregates.

Some embodiments provide several other objects and advantages, some of which are discussed below. Material compositions have been specially formulated to provide high thermal insulation, thus low thermal conductivity. In some embodiments, the plaster material compositions reduce wall heat transfer by 25%. Heat transfer rate through a wall is equal to temperature difference on two surfaces divided by the total thermal resistance of the wall. In some embodiments, the plaster material compositions reduce heat flux by 10%. Heat flux is the amount of heat transferred per unit area per unit time to or from a surface on which the bio-plaster material is applied.

Another advantage of the plaster material compositions in accordance with the present disclosure is that the compositions are formulated with materials that have excellent sound-absorbing properties. This allows the plaster to absorb a portion of the sound energy that hits its surface, reducing sound reflections and echoes. By reducing sound reflections, as described above, the plaster material compositions are able to improve the overall acoustic performance of a space. This is especially important in rooms where clear speech, music, or other audio quality is critical.

Another advantage of the plaster material composition in accordance with the present disclosure is that it is able to be applied to ceilings and walls, just like regular plaster or drywall, and it is able to be customized to match the aesthetics of the space. The plaster material composition in accordance with the present disclosure is also able to be painted or textured to blend seamlessly with the design of the room.

The plaster material compositions in accordance with the present disclosure are durable and long-lasting, making them a practical choice for commercial and institutional buildings where the plaster material compositions may be subject to wear and tear.

The plaster material compositions in accordance with the present disclosure are able to add an extra layer of safety to the space in which they are installed, as such bio-plaster material is fire-resistant.

Another advantage of the plaster material compositions in accordance with the present disclosure is breathability compared to traditional plasters, allowing moisture to escape from the walls. This characteristic is able to help prevent issues, such as, but not limited to, mold and mildew growth.

Apart from the above, the plaster material compositions in accordance with the present disclosure do not require any curing, have low carbon footprint, are light-weight, and provide a crack-free wall. For example, in some embodiments, the plaster material compositions produce only 100 gr CO₂ eq per kg, which is 22% lower than cement plaster.

The plaster material composition in accordance with the present disclosure is able to be used for internal wall surfaces made up of various types of blocks, bricks, stone, concrete, and the like. In some embodiments, plaster material having the plaster material composition is able to be applied as base coat to improve thermal resistance of substrates. In some embodiments, the plaster material having the plaster material composition is able to be applied as a single coat application. In such cases, the plaster material is able to be applied in a single layer, up to 12 mm in thickness and such a single application design speeds up the overall work progress.

Certain terms and phrases have been used throughout the disclosure and will have the following meanings in the context of the ongoing disclosure.

“Concrete” for the purposes of the present disclosure refers to a hard strong building material.

“Gypsum” for the purposes of the present disclosure refers to a soft sulfate mineral composed of calcium sulfate dihydrate. Gypsum is widely used as a main constituent in many forms of plaster and drywall. Gypsum board is primarily used as a finish for walls and ceilings. Gypsum is also referred to as plasterboard, sheetrock, or drywall in construction applications. Further, gypsum blocks are used similar to concrete blocks in building construction.

“Calcium sulfate hemihydrate” for the purposes of the present disclosure refers to the compound CaSO4·½H2O.

“Polymer” for the purposes of the present disclosure includes, but is not limited to, homopolymers, copolymers, graft copolymers, and blends and combinations thereof.

“Thermal conductivity” for the purposes of the present disclosure refers to a measure of the ability of a material to conduct heat. Thermal conductivity is usually denoted by the symbol “k” and is measured in watts per meter-kelvin (W/(m·K)). Various methods exist for measuring thermal conductivity, and in the present disclosure, ASTM C 518 is employed for measurement purposes. Low thermal conductivity is associated with good thermal insulation, while high thermal conductivity is associated with efficient heat conduction. Thus, thermal conductivity and thermal insulation are inversely related.

In accordance with some embodiments, the present disclosure is directed to a plaster material composition for use in construction. The plaster material composition is able to include a binder comprising calcium sulphate hemihydrate, a filler comprising cork, wherein the filler is an agro-based bio fiber, a polymer comprising vinyl acetate and an additive comprising modified amino acid. The composition provides high thermal insulation.

In some embodiments, the material composition, so disclosed, is able to be used in one or more construction activities. For such embodiments, the plaster material composition is able to be added to water in a mixer. In some embodiments, the plaster material composition is able to be blended in the mixer for a predetermined amount of time at a predetermined speed until a bio-plaster material having a predetermined consistency and workability is achieved.

These and other embodiments are discussed in detail below.

In some embodiments, the plaster material composition includes a binder comprising calcium sulphate hemihydrate, which is made of gypsum. The quantity of calcium sulphate hemihydrate is between 40-60% of the composition by volume. In some embodiments, the quantity of the calcium sulphate hemihydrate is 50% of the composition by volume. The quality of calcium sulphate hemihydrate directly influences various technical properties, such as compressive strength, flexural strength, initial setting time, reactions to fire, wet density, and thermal conductivity of the plaster material composition. Calcium sulphate hemihydrate is able to react with other fundamental components of the material composition, as mentioned above, to minimize or eliminate shrinkage cracks while imparting other useful properties to the disclosed material composition. Further, calcium sulphate hemihydrate provides higher compressive strengths as compared to other forms of calcium sulfate. Early setting time is an intrinsic property of all calcium sulfates and calcium sulphate hemihydrates. Calcium sulphate hemihydrate typically loses its plasticity within 10 minutes of being mixed with water.

In some embodiments, the plaster material composition includes filler comprising cork, the filler being an agro-based bio fiber. The quantity of cork is between 40-60% of the composition by volume. In some embodiments, the quantity of the cork is 50% of the composition by volume. Cork's bubble-form structure, low density, and natural fire-retardant feature makes it suitable for acoustic and thermal insulation. Cork is a natural material derived from the bark of the cork oak tree. As cork is a lightweight material, it is easy to handle and transport. Cork is an excellent insulator, both thermally and acoustically. Cork helps regulate temperature and is able to reduce noise transmission. When added to the plaster material as a filler, the natural insulating properties of cork are able to enhance the thermal insulation of the plaster material, contributing to better energy efficiency in buildings. The sound-absorbing characteristics of cork are able to contribute to improved acoustics when added to the plaster material. It should be noted that the present disclosure is not limited to cork, and any other agro-based bio fiber is also able to be used in accordance with the disclosed embodiments.

In some embodiments, the plaster material composition includes a polymer comprising vinyl acetate. The quantity of vinyl acetate is between 0.5-1% of the calcium sulphate hemihydrate by volume. In some embodiments, the quantity of vinyl acetate is 1% of the calcium sulphate hemihydrate by volume. Such polymer is added to the plaster material composition to significantly improve its properties, such as abrasion resistance, and compressive strength. In some embodiments, vinyl acetate polymers are able to be prepared in a known manner by emulsion or dispersion polymerization. The vinyl acetate polymers are able to be added in the form of aqueous dispersions or in the form of the water-redispersible powders produced by drying the dispersions obtained in the polymerization and optionally mixed with additives to the plaster material composition before molding, in particular together with the mixing water. The polymers of vinyl acetate are able to contain, as protective colloids, ionic and/or nonionic emulsifiers, which are usually present in such polymers from their production, or dispersants of the aforementioned classes that are mixed therewith.

Further, because of the hydrophobic properties of the polymer, the polymer helps decrease the water content in the plaster material composition and/or the resulting bio-plaster material. In some embodiments, the amounts of the polymer, along with the binder, filler and the additive correspond to a water consumption rate of the material composition. In some embodiments, the water consumption rate of the plaster material composition is less than 5%.

In some embodiments, the plaster material composition includes an additive comprising modified amino acid. The quantity of the modified amino acid is between 0.001-0.01% of the calcium sulphate hemihydrate by volume. In some embodiments, the quantity of the modified amino acid is 0.01% of the calcium sulphate hemihydrate by volume. As the binder, such as, calcium sulfate hemihydrate, possesses the intrinsic property of quick setting, the addition of modified amino acids alters such quick-setting property. The addition of modified amino acids further extends the setting time as needed, thereby increasing the pot life of the plaster material. The modified amino acid is available in powder form and is able to be added to other ingredients of the plaster material with ease.

Material compositions in accordance with some embodiments have many applications in architecture, such as filling, smoothing, and finishing internal walls made up of various blocks, bricks, and stones. Material compositions in accordance with some embodiments have low shrinkage and high adhesion to the substrate providing a crack-free wall surface.

Further, the present material compositions are able to be made available in a prepackaged form, and water is added in an amount that is able to be sufficient to produce bio-plaster material with a predetermined range of flowable consistency. In some embodiments, one package of the plaster material composition weighs around 50 pounds (lbs). Typically, the shelf life of the plaster material composition is about 6 months from date of packaging, if stored properly, such as, stored at an elevated place on the ground, away from moisture. In some embodiments, the unit weight of the plaster material composition is in a range between 1100-1200 kg/m³. A person of ordinary skill in the art will understand that other configurations and scenarios are also possible for the composition.

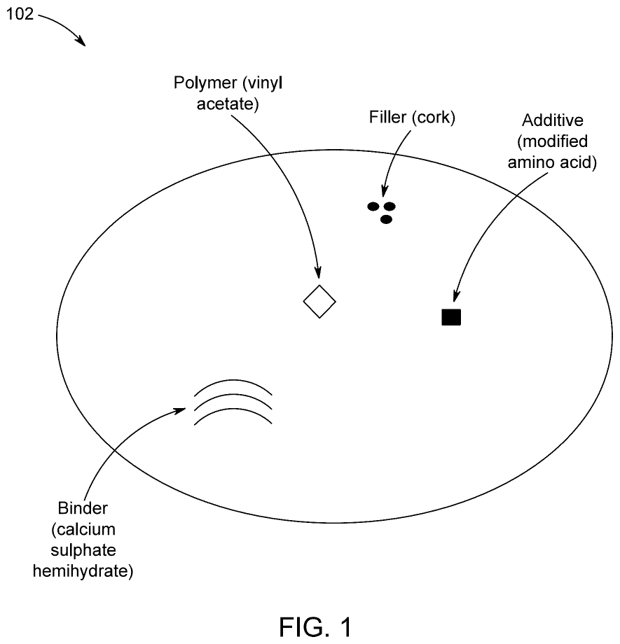

FIG. 1 illustrates ingredients collated in the form of a group 102 that make up an exemplary material composition, in accordance with some embodiments of the present disclosure. In some embodiments, the ingredients are able to include, but are not limited to, a binder that includes calcium sulphate hemihydrate, a filler that includes cork and is an agro-based bio fiber, a polymer that includes vinyl acetate, and an additive that includes modified amino acid. Due to good thermal conductivity of cork plaster, the bio-composite plaster material provides high thermal insulation as compared to the conventional plaster.

Further, when making up bio-composite plaster material having a predetermined consistency, water is able to be mixed with the ingredients for a first predetermined amount of time. Thus, in some embodiments, the group 102 is able to be used to manufacture the exemplary material composition. Furthermore, a coat of the bio-composite plaster material is able to be applied on a surface during the construction activity.

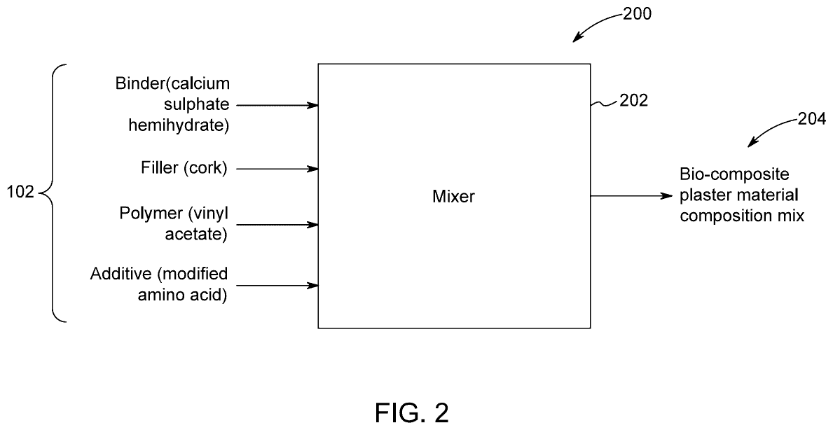

FIG. 2 illustrates an arrangement 200 for manufacturing material compositions, in accordance with some embodiments of the present disclosure.

The arrangement 200 includes a mixer 202 that receives as inputs the ingredients 102 and produces a bio-composite plaster material mix 204. The ingredients 102 include the binder that includes calcium sulphate hemihydrate, the filler that includes cork and is an agro-based bio fiber, the polymer that includes vinyl acetate, and the additive that includes modified amino acid.

In some embodiments, all these ingredients 102 are added in the mixer 202 with water in appropriate quantities according to the desired material composition. The table below (Table 1) indicates the appropriate quantities of the components of the plaster material composition in accordance with some embodiments. The quantities indicated in Table 1 are non-limiting. Other ingredients and quantities are contemplated.

TABLE 1

| Component | Quantity |
|---|---|
| Calcium sulfate hemihydrate | 40-60% of the composition by volume |
| Cork | 40-60% of the composition by volume |
| Vinyl Acetate | 0.5-1% of the calcium sulphate |
| | hemihydrate by volume |
| Modified Amino Acid | 0.001-0.01% of the calcium sulphate |
| | hemihydrate by volume |

A person of ordinary skill in the art will understand that a mixer blends and mixes materials to produce a resulting mix. In some embodiments, the mixer 202 includes, but is not limited to, batch mixers such as, drum type mixers and pan type mixers, and continuous mixers, which are able to be used for the present disclosure. A person of ordinary skill in the art will understand that other configurations are also possible for the mixer 202.

Referring to FIG. 2, once the ingredients 102 are mixed in the mixer 202 at a predetermined speed for a predetermined amount of time, a consistent and workable material composition mix, that is, the bio-plaster material mix 204 (with a predetermined range of flowable consistency) is obtained. This consistent and workable bio-plaster material mix 204 is also able to be used for various purposes such as, but not limited to, interior ceilings coating, interior wall coating, and a skim coat for concrete, block, brick, and masonry wall substrates, to name only a few examples. Those skilled in the art will recognize that applicable standards for the bio-plaster material mix 204 are BS EN 13279-1-C4/30/2 test standards.

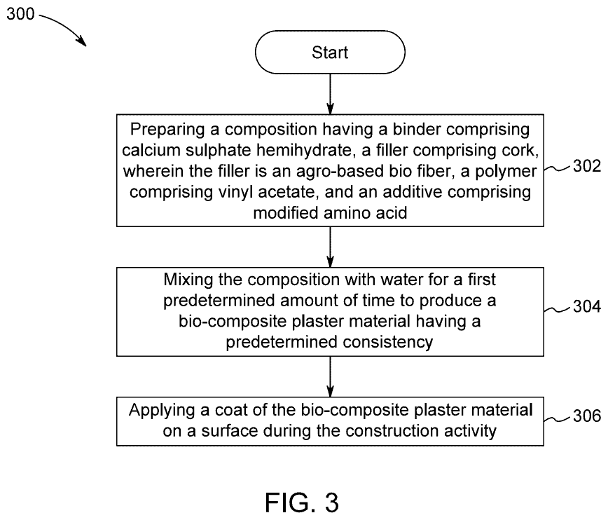

FIG. 3 illustrates a flowchart specifying the steps of a method 300 for manufacturing or preparing material compositions for construction activities, in accordance with some embodiments of the present disclosure, such as in architectural applications. The plaster material composition described herein is able to be equivalent to the bio-plaster material mix 204 of FIG. 2 in its functionality and characteristics, as described above.

Although specific operations are disclosed herein, such operations are examples and are non-limiting. In different embodiments, to name only a few examples, the method 300 includes other steps, the sequence of the steps is modified, some steps are omitted, or any combination of these variations may be incorporated. The steps of the method 300 are able to be automated or semi-automated. In various embodiments, one or more of the operations of the method 300 are able to be controlled or managed by software, by firmware, by hardware, or by any combination thereof, but is not limited to such.

In some embodiments, the method 300 includes processes in accordance with the present disclosure which are able to be controlled or managed by a processor(s) and electrical components under the control of a computer or computing device comprising computer-readable media containing non-transitory computer-executable instructions or code that when executed by the processor(s) perform the steps of the method 300. The readable and executable instructions (or code) are able to reside, for example, in data storage such as volatile memory, non-volatile memory, and/or mass data storage, as only some examples. In some embodiments, automation of the method 300 through a computer employs various peripherals such as sensors, robotic arms, and the like.

Referring to FIG. 3, at step 302, prepacked bags of material composition are added to water (for example, in a predetermined amount) in a mixer (for example, mixer 202 of FIG. 2). In some embodiments, the plaster material composition includes the binder that includes calcium sulphate hemihydrate, the filler that includes cork and is an agro-based bio fiber, the polymer that includes vinyl acetate, and the additive that includes modified amino acid.

Next, at step 304, the plaster material composition is blended or mixed with water in the mixer 202 at a predetermined speed for a predetermined amount of time to obtain a bio-plaster material mix 204 having a predetermined consistency and workability. The bio-plaster material mixes 204, thus obtained is a homogenous paste free of lumps. In some embodiments, the predetermined amount of time for which the ingredients 102 of the bio-plaster material composition is blended with water are able to vary but does not exceed 5 minutes, though other times are contemplated. In some embodiments, the first predetermined amount of time for which the bio-plaster material composition is blended is able to be based at least on a batch size of the bio-plaster material mix 204 and/or a type of the mixer 202 used for such purpose.

Next, the method 300 includes steps of using the material composition, depicted as optional step 306. At step 306, a coat of a predetermined thickness of the plaster material composition and/or the bio-plaster material mix 204 is applied onto a substrate. The substrate is able to refer to concrete, block, brick, and masonry walls, as a few examples. For application of the plaster material composition on a surface, such as a wall, a ceiling, or a drywall, the surface should be prepared before applying the plaster material composition for best results. For example, the surface should be clean, smooth, dry, and free from any loose materials, grease and oil. The surface should be inspected, and any uneven areas should be repaired, patched, and leveled. Next, pre-water or dampen the surface with clean water, if necessary to avoid moisture suction of substrates from the bio-plaster material mix 204. Thereafter, a thin coat of the plaster material composition and/or the bio-plaster material mix 204 should be applied on to the surface and/or the substrate to obtain good adhesion using a tool, such as a steel trowel, a wooden float, or a mechanical spray equipment. In some embodiments, the maximum thickness of the coat of the plaster material composition and/or the bio-plaster material mix 204 should not exceed 12 mm thickness. If the maximum thickness of the coat of the plaster material composition exceeds 12 mm thickness, in some embodiments, a basecoat or a scratch coat is highly required.

While the plaster material composition and/or the bio-plaster material mix 204 is still fresh, the tools and containers should be cleaned with water. Surfaces should be cleaned with a damp cloth before they dry.

Embodiments of the plaster material composition and the methods of making and using them provide a versatile, economical, and environmentally friendly architectural product. The bio-plaster material mix 204 corresponding to the plaster material composition in accordance with the present disclosure does not contain cement, hydraulic binder, or any cementitious hydraulic binder, and thus is a green material. Other advantages of the plaster material composition and/or the resulting bio-plaster material mix 204 are high thermal insulation (thus low thermal conductivity, and reduced wall heat transfer and heat flux), low carbon print, crack-free wall, light weight, excellent sound absorption, good aesthetics, highly durable, fire resistant, and highly breathable.

Further, the plaster material compositions and/or the resulting bio-plaster material mix 204 have minimal environmental impact. The carbon footprint of the bio-plaster material mix 204 is 100 gr CO₂ eq/kg which is 22% lower than conventional plaster (130 gr CO₂ eq/kg). As the insulation materials create the majority of carbon emissions of a wall, using the bio-plaster material mix 204 significantly decreases the required insulation and therefore it has a high impact on the carbon footprints of the walls. Other exemplary impact categories of the plaster material compositions and/or the resulting bio-plaster material mix 204 as compared to conventional plaster materials are enlisted in the table below (Table 2). The exemplary impact categories and corresponding exemplary values indicated in Table 2 are non-limiting. Other impact categories and corresponding values are contemplated.

TABLE 2

| | | Bio-Plaster | Conventional |
|---|---|---|---|
| Impact Category | Unit | Material Mix 204 | Cement Plaster |
| Global warming | kg CO₂ eq | 0.10 | 0.13 |
| Ozone formation, | kg NOₓ eq | 0.0002 | 0.0004 |
| Human health | | | |
| Ozone formation, | kg NOₓ eq | 0.0002 | 0.0004 |
| Terrestrial ecosystems | | | |
| Terrestrial acidification | kg SO₂ eq | 0.0001 | 0.0003 |
| Freshwater | kg P eq | 0.000003 | 0.000016 |
| eutrophication | | | |
| Marine eutrophication | kg N eq | 0.0000007 | 0.0000014 |
| Water consumption | m³ | 0.0002 | 0.002 |

Further, the plaster material compositions and/or the resulting bio-plaster material mix 204 has significantly lower damage to human health compared with conventional cement plasters. These and other like advantages make the disclosed embodiments a multifunctional, unified, and improved plaster material composition and/or the resulting bio-plaster material mix 204.

In some embodiments, a system (in an example, a computer) for performing the steps of method 300 is automated. In some embodiments, the computer is able to comprise a memory storing computer-executable instructions that when executed by a processor(s) perform the steps of method 300.

The terms “comprising,” “including,” and “having,” as used in the specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention. The term “connecting” includes connecting, either directly or indirectly, and “coupling,” including through intermediate elements.

The disclosure has been described with reference to various specific and preferred embodiments and techniques. However, it should be understood that many variations and modifications may be made while remaining within the spirit and scope of the disclosure. It will be apparent to one of ordinary skill in the art that methods, devices, device elements, materials, procedures, and techniques other than those specifically described herein can be applied to the practice of the disclosure as broadly disclosed herein without resort to undue experimentation.

All art-known functional equivalents of methods, devices, device elements, materials, procedures, and techniques described herein are intended to be encompassed by this disclosure. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the building blocks described herein contain optional features that can be individually or together applied to any other embodiment shown or contemplated here to be mixed and matched with the features of that building block.

While the disclosure has been described with respect to a limited number of embodiments, those skilled in the art, having benefit of this disclosure, will appreciate that other embodiments can be devised which do not depart from the spirit and scope of the disclosure as disclosed herein.

We claim:

1. A composition for a bio-composite plaster material, comprising:
a binder comprising calcium sulphate hemihydrate;
a filler comprising cork, wherein the filler is an agro-based bio fiber;
a polymer comprising vinyl acetate; and
an additive comprising modified amino acid,
wherein the composition provides high thermal insulation.

2. The composition of claim 1, wherein:
a quantity of the calcium sulphate hemihydrate is between 40-60% of the composition by volume;
a quantity of the cork is between 40-60% of the composition by volume;
a quantity of the modified amino acid is between 0.001-0.01% of the calcium sulphate hemihydrate by volume; and
a quantity of the vinyl acetate is between 0.5-1% of the calcium sulphate hemihydrate by volume.

3. The composition of claim 1, wherein an amount of water is added to the composition such that a homogeneous lump-free paste is formed with a consistency within a predetermined range.

4. The composition of claim 3, wherein the bio-composite plaster material excludes curing for setting.

5. The composition of claim 1, wherein the composition is cement-free.

6. The composition of claim 1, wherein the composition is sand-free.

7. The composition of claim 1, wherein a coat of the bio-composite plaster material is applied as a base coat to improve thermal resistance of substrates.

8. The composition of claim 1, wherein a coat of the bio-composite plaster material is applied on internal wall surfaces.

9. The composition of claim 1, wherein the bio-composite plaster material is used for a single coat application.

10. The composition of claim 1, wherein properties of the composition comprise one or more of:
a compressive strength of at least 2 N/mm²;
a flexural strength of at least 1 N/mm²;
an initial setting time of between 0.45 to 0.60 minutes;
a wet density of between 1100 to 1200 Kg/m³; and
a thermal conductivity of between 0.1 to 0.2 W/m·K.

11. A method of using a composition for a bio-composite plaster material, the method comprising:
preparing the composition having:
a binder comprising calcium sulphate hemihydrate,
a filler comprising cork, wherein the filler is an agro-based bio fiber,
a polymer comprising vinyl acetate, and
an additive comprising modified amino acid;
mixing the composition with water for a first predetermined amount of time to produce a bio-composite plaster material having a predetermined consistency; and
applying a coat of the bio-composite plaster material on a surface during the construction activity,
wherein the bio-composite plaster material provides high thermal insulation.

12. The method of claim 11, wherein the predetermined consistency includes a homogeneous lump-free paste.

13. The method of claim 11, further comprising applying the coat of the bio-composite plaster material on internal wall surfaces.

14. The method of claim 11, further comprising applying the coat of the bio-composite plaster material as a base coat to improve thermal resistance of substrates.

15. The method of claim 11, wherein the composition is used for a single coat application.

16. The method of claim 11, wherein the bio-composite plaster material excludes curing for setting.

17. A method of preparing a bio-composite plaster material, the method comprising:
preparing a composition comprising:
a binder comprising calcium sulphate hemihydrate;
a filler comprising cork, wherein the filler is an agro-based bio fiber;
a polymer comprising vinyl acetate; and
an additive comprising modified amino acid; and
mixing the composition with water in a mixer for a first predetermined amount of time to produce a bio-composite plaster material having a predetermined consistency,
wherein the bio-composite plaster material provides high thermal insulation.

18. The method of claim 17, wherein properties of the bio-composite plaster material comprise one or more of:
a compressive strength of at least 2 N/mm²;
a flexural strength of at least 1 N/mm²;
an initial setting time of between 0.45 to 0.60 minutes;
a wet density of between 1100 to 1200 Kg/m³; and
a thermal conductivity of between 0.1 to 0.2 W/m·K.
